(19) United States
(12) Patent Application Publication
(10) Pub. No.: US 2025/0050571 A1
(43) Pub. Date: Feb. 13, 2025

(54) PASTE-PROCESSED ULTRA HIGH MOLECULAR WEIGHT POLYETHYLENE EXPANDED INTO DENSE ARTICLES

(71) Applicant: W. L. Gore & Associates, Inc., Newark, DE (US)

(72) Inventors: Spencer D. Jackman, Flagstaff, AZ (US); Guy A. Sbriglia, Christiana, PA (US); Jason J. Strid, Elkton, MD (US)

(21) Appl. No.: 18/720,883

(22) PCT Filed: Dec. 8, 2022
(86) PCT No.: PCT/US2022/052245

§ 371 Date: Jun. 17, 2024

Related U.S. Application Data
(60) Provisional application No. 63/290,154, filed on Dec. 16, 2021.

(51) Int. Cl. B29C 55/00; B29C 55/12; B29K 23/00; B29L 7/00; C08F 10/02; C08J 5/18

(52) U.S. Cl. CPC B29C 55/005; B29C 55/12; C08F 10/02; C08J 5/18; B29K 2023/0683; B29K 2995/0065; B29K 2995/0077; B29K 2995/0088; B29L 2007/007; C08J 2323/04

(57) ABSTRACT

Paste-processed ultra high molecular weight polyethylene (UHMWPE) polymers, and processes for the formation of dense UHMWPE films from a highly crystalline ultra high molecular weight polyethylene polymer are provided. The UHMWPE films described herein may be manufactured by 1) compressing a dry, porous UHMWPE tape and then stretching above the melt temperature of the UHMWPE polymer; 2) expanding a dry, porous UHMWPE tape above the melt of the UHMWPE polymer without compression; or 3) expanding a dry, porous UHMWPE tape below the melt of the UHMWPE polymer to form a porous membrane and subsequently compressing the porous membrane at temperatures above the melt of the UHMWPE polymer to forma dense film. This dense film may be further stretched biaxially to enhance the properties of the dense film.

### CROSS-REFERENCE TO RELATED APPLICATION

This application is a national phase application of PCT Application No. PCT/US2022/052245, internationally filed on Dec. 8, 2022, which claims the benefit of Provisional Application No. 63/290,154, filed Dec. 16, 2021, both of which are incorporated herein by reference in their entireties for all purposes.

### FIELD

The present disclosure relates generally to paste-processed ultra high molecular weight polyethylene (UHMWPE) polymers, and more specifically to processes for the formation of dense films from a highly crystalline ultra high molecular weight polyethylene polymer.

### BACKGROUND

Ultra high molecular weight polyethylene is well known in the art. Articles made from ultra high molecular weight polyethylene possess properties such as toughness, impact strength, abrasion resistance, low coefficient of friction, gamma resistance, and resistance to attack by solvents and corrosive chemicals. Because of the favorable attributes associated with ultra high molecular weight polyethylene, ultra high molecular weight polyethylene has been utilized in a variety of applications, such as load-bearing components of articulating joint prostheses, vibration dampener pads, hydraulic cylinders, sports equipment, including, but not limited to, skis, ski poles, goggle frames, protective helmets, climbing equipment, and in specialized applications in aerospace.

UHMWPE polymers can be processed by compression molding, ram extrusion, gel spinning, and sintering. However, some conventional processes have one or more undesirable feature or attribute, such as requiring high solvent levels, and/or are costly or slow to process due to the high viscosity of the UHMWPE polymer. Thus, there exists a need in the art for a paste-process for making an UHMWPE intermediate (e.g., tape or membrane) that is then processed into a dense film having superior mechanical and optional properties, such as high strength, excellent barrier properties, optical uniformity, low haze, and transparency.

### SUMMARY

Provided herein are dense films formed from a paste-processed ultra high molecular weight polyethylene (UHMWPE) polymer, and processes for the formation of these films from a highly crystalline ultra high molecular weight polyethylene polymer.

According to a first Embodiment (“Embodiment 1”), provided is dense, ultra-high molecular weight polyethylene (UHMWPE) film including: a first endotherm from about 135° C. to about 143° C.; a second endotherm from about 145° C. to about 155° C.; and a total luminous transmittance of at least about 90% measured from 360 nm to 780 nm.

Embodiment 2 is the dense UHMWPE film of Embodiment 1, wherein the UHMWPE film has a matrix tensile strength in the machine direction (MD) of least 200 MPa.

Embodiment 3 is the dense UHMWPE film of Embodiments 1 or 2, wherein the UHMWPE film has a matrix tensile strength in the transverse direction (TD) of least 400 MPa.

Embodiment 4 is the dense UHMWPE film of any of Embodiments 1-3, wherein the ratio of the matrix tensile strength MD:TD is from about 1:5 to about 5:1.

Embodiment 5 is the dense UHMWPE film of any of Embodiments 1-4, wherein the UHMWPE film has CO₂ permeability, or an O₂ permeability or a N₂ permeability of less than 10 barrer.

Embodiment 6 is the dense UHMWPE film of any of Embodiments 1-5, wherein the UHMWPE film has a thickness from 0.0005 mm to 1 mm.

Embodiment 7 is the dense UHMWPE film of any of Embodiments 1-6, wherein the dense UHMWPE film is formed from a UHMWPE polymer having a molecular weight from about 2,000,000 g/mol to about 10,000,000 g/mol and a melt enthalpy greater than 190 J/g.

Embodiment 8 is composite includes the dense UHMWPE film of any of Embodiments 1-7.

Embodiment 9 is an article includes the dense UHMWPE film of any of Embodiments 1-8.

According to a tenth Embodiment (“Embodiment 10”), provided is a method of forming a dense UHMWPE film including: forming a dry, porous UHMWPE tape from a UHMWPE polymer having a molecular weight of at least 2,000,000 g/mol and a melt enthalpy of at least 190 J/g; and compressing the dry, porous UHMWPE tape below the melting temperature of the UHMWPE polymer; and stretching the UHMWPE tape in at least two directions at a temperature above the melt temperature of the UHMWPE polymer to form the dense UHMWPE film, wherein the dense UHMWPE film includes: a first detectable endotherm from about 135° C. to about 143° C.; and a second detectable endotherm from about 145° C. to about 155° C.

Embodiment 11 is the method of Embodiment 10 wherein the dense UHMWPE film comprises a total luminous transmittance of at least about 98% measured from 250 nm to 800 nm.

Embodiment 12 is the method of Embodiment 10 or 11, wherein the forming step includes: providing a paste includes the UHMWPE polymer as a powder and a lubricant; shaping the paste into a tape; removing the lubricant to form the dry, porous UHMWPE tape; and stretching the tape to form a dense UHMWPE film.

Embodiment 13 is the method of Embodiment 10-12, wherein the step of stretching the compressed UHMWPE tape is conducted at a temperature from 140° C. to 170° C. at a rate from about 0.1% to 20,000%/second.

Embodiment 14 is the method of Embodiment 10-13, wherein the dense UHMWPE film additionally comprises a machine direction matrix tensile strength to transverse direction matrix tensile strength ratio from about 1:5 to about 5:1 and a matrix tensile strength of at least 500×500 (MD×TD) MPa; a CO₂, O₂ or N₂ permeability from 0.01 to 10 barrer; and a water vapor permeation coefficient less than 0.02 g-mm/m²/day.

According to a fifteenth Embodiment (“Embodiment 15”), provided is a method of forming a dense UHMWPE film, including: forming a dry, porous UHMWPE tape from a UHMWPE polymer having a molecular weight of at least 2,000,000 g/mol and a melt enthalpy of at least 190 J/g, wherein the dry, porous UHMWPE tape; and stretching the dry, porous UHMWPE tape in at least two directions at a temperature above the melt temperature of the UHMWPE polymer to form the dense UHMWPE film, wherein the dense UHMWPE film comprises: a first detectable endotherm from about 135° C. to about 143° C.; and a second detectable endotherm from about 145° C. to about 155° C.

Embodiment 16 is the method of Embodiment 15, wherein the forming step includes: providing a paste includes the UHMWPE polymer as a powder and a lubricant; shaping the paste into a tape; removing the lubricant to form the dry, porous UHMWPE tape; and stretching the tape to form a dense UHMWPE film.

Embodiment 17 is the method of Embodiment 15 or 16, wherein the step of stretching the dry, UHMWPE tape is conducted at a temperature from 140° C. to 170° C. at a rate from about 0.1% to 20,000%/second.

Embodiment 18 is the method of Embodiment 15-17, wherein the dense UHMWPE film further includes a machine direction matrix tensile strength to transverse direction matrix tensile strength ratio from about 1:5 to about 5:1 and a matrix tensile strength of at least 200×200 (MD×TD) MPa; and a CO₂, O₂ or N₂ permeability from 0.01 to 10 barrer.

According to a nineteenth Embodiment (“Embodiment 19”), provided is a method of forming a dense UHMWPE film, including: (a) forming a porous UHMWPE tape from a UHMWPE polymer having a molecular weight of at least 2,000,000 g/mol and a melt enthalpy of at least 190 J/g, wherein the porous UHMWPE tape, (b) expanding the porous UHMWPE tape below the melt temperature of the porous UHMWPE tape to form a porous membrane; and (c) compressing the porous UHMWPE membrane at a pressure of at least 1 MPa thereby forming the dense UHMWPE film, including: a first endotherm from about 135° C. to about 143° C.; a second detectable endotherm from about 145° C. to about 155° C.

Embodiment 20 is the method of Embodiment 19 further including (d) stretching the dense UHMWPE film above the melting temperature of the UHMWPE polymer.

Embodiment 21 is the method of Embodiment 19 or 20, wherein the stretching and compressing steps occur simultaneously.

Embodiment 22 is the method of Embodiment 19-21, wherein the post-compression stretching step occurs at a temperature from about 140° C. to about 170° C.

Embodiment 23 is the method of Embodiment 19-22, wherein the dense UHMWPE film further includes a machine direction matrix tensile strength to transverse direction matrix tensile strength ratio from about 1:5 to about 5:1 and a matrix tensile strength of at least 200×200 (MD×TD) MPa; and a water vapor permeation coefficient less than 0.21 g-mm/m²/day.

Embodiment 24 is the method of Embodiment 10-23, wherein the stretching step includes biaxial or radial stretching.

The foregoing Embodiments are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a differential scanning calorimetry (DSC) thermogram of the UHMWPE powder of all Examples described herein, showing a melt enthalpy of 232.9 J/g.

FIG. 2 is a differential scanning calorimetry (DSC) thermogram depicting two distinct melting points associated with the UHMWPE dense film of Example 1.

FIG. 3 is a differential scanning calorimetry (DSC) thermogram depicting two distinct melting points associated with the UHMWPE dense film of Example 2.

FIG. 4 is a differential scanning calorimetry (DSC) thermogram depicting two distinct melting points associated with the UHMWPE dense film of Example 3a.

FIG. 5 is a plot of the comparative permeability to nitrogen, oxygen, and carbon dioxide gas of the UHMWPE dense films described in Examples 1, 2, and 4b.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

The disclosure relates to dense, ultra-high molecular weight polyethylene (UHMWPE) films, articles, and composites including these films, and methods to making dense UHMWPE articles via paste-processing of UHMWPE polymers to make tapes or membranes that are subsequently subjected to processing conditions (e.g., heated compression or biaxial stretching or heated compression in combination with biaxial stretching) suitable for the formation of a dense film.

The UHMWPE film may be formed from an ultra-high molecular weight polyethylene polymer that may have an average molecular weight (Mw) of at least about 2,000,000 g/mol and a high degree of crystallinity. In exemplary embodiments, the UHMWPE polymer may have an average molecular weight in the range of from about 2,000,000 g/mol to about 10,000,000 g/mol, of from about 4,000,000 g/mol to about 10,000,000 g/mol, of from about 4,000,000 g/mol to about 8,000,000 g/mol, or may have an average molecular weight in the range of any other range encompassed by these endpoints.

The UHMWPE polymer may have a high crystallinity. The crystallinity of the UHMWPE polymer may be measured by differential scanning calorimetry (DSC). As used herein, the phrases “high crystallinity” or “highly crystalline” are meant to describe a UHMWPE polymer that has a first melt enthalpy greater than 190 J/g as measured by DSC. In another embodiment, the UHMWPE polymer has a first melt enthalpy greater than 195 J/g, 200 J/g, 205 J/g, 210 J/g, 215 J/g, 220 J/g, 225 J/g or 230 J/g.

In addition, the UHMWPE polymer may be a homopolymer of ethylene or a copolymer of ethylene and at least one comonomer. Suitable comonomers that may be used to form a UHMWPE copolymer include, but are not limited to, an alpha-olefin or cyclic olefin having 3 to 20 carbon atoms. Non-limiting examples of suitable comonomers include 1-butene, 1-pentene, 1-hexene, 1-heptene, 1-octene, cyclohexene, and dienes with up to 20 carbon atoms (e.g., butadiene or 1,4-hexadiene). Comonomers may be present in the UHMWPE copolymer in an amount from about 0.001 mol % to about 10 mol %, from about 0.01 mol % to about 5 mol %, from about 0.1 mol % to about 1 mol %, or any other amount encompassed within these endpoints.

Additionally, UHMWPE films may have a first endotherm associated with the UHMWPE polymer used from about 135° C. to about 143° C. It is to be noted that the terms “melting temperature”, “melt temperature”, and “melting point” may be used interchangeably herein. In at least one exemplary embodiment, the UHMWPE polymer has a melting point of approximately 140° C. Subsequent re-melting of the UHMWPE polymer occurs at a temperature from about 127° C. to about 137° C.

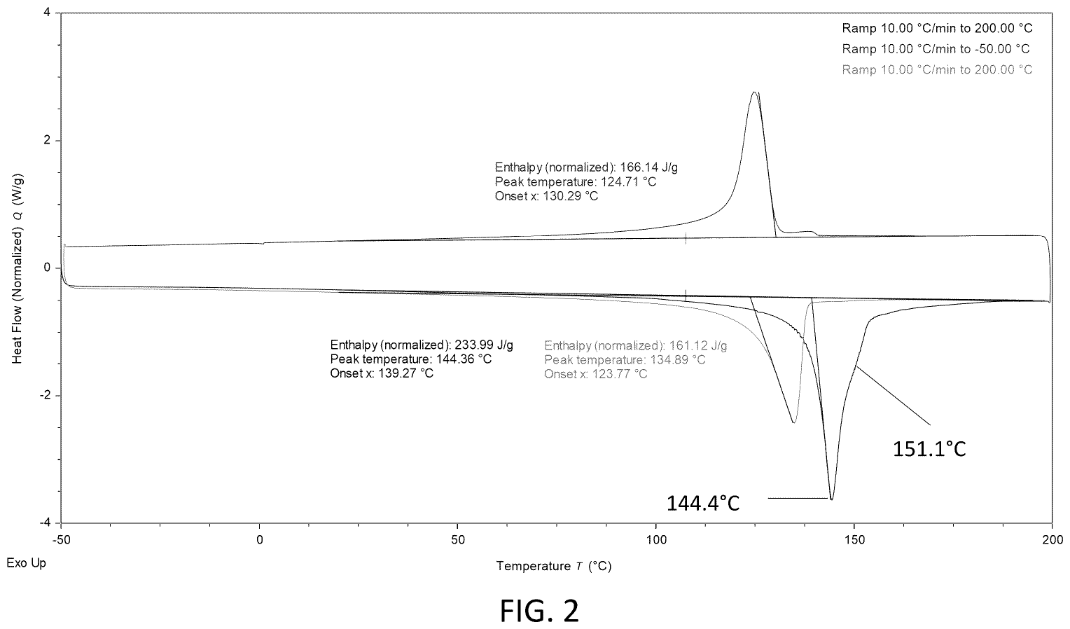

As noted, the UHMWPE polymer particles are initially mixed with a suitable lubricant (such as an isoparaffinic hydrocarbon) following the general process described in U.S. Pat. No. 9,926,416 B2. The lubricated polymer particles are then formed into a tape having the presence of a fibrillar structure (i.e., fibrils are present). The tape may be dried (to remove the lubricant) prior to forming a dense UHMWPE film using heated compression, biaxial stretching or a combination thereof. The densification conditions may be controlled to retain a detectable DSC endotherm peak that is indicative of the presence of residual fibrillar structure. In addition, the UHMWPE film may have an endotherm from about 145° C. to about 155° C., or about 150° C., that is associated with the fibrils in the film. Differential Scanning Calorimetry (DSC) can be used to identify the melting temperatures (crystalline phases) of the UHMWPE polymers. This approximate 150° C. peak (or endotherm) is indicative of the presence of fibrils in the UHMWPE dense film. FIGS. 2-4 show DSC thermographs for a UHMWPE films according to the invention showing two distinct peaks. It is to be appreciated that an endothermic peak of about 150° C. is not present in conventional processed UHMWPE porous membranes, tapes or films.

The dense UHMWPE films provided herein may have superior optical properties. For example, the film may have a total luminous transmittance of at least about 90%, at least about 92%, at least about 94%, at least about 96%, or at least about 98% measured from 360 nm to 780 nm. In some exemplary embodiments, the film may have a total luminous transmittance of from about 90% to about 98% measured from 360 nm to 780 nm or may have any luminous transmittance encompassed by these endpoints.

Similarly, the dense film may have an average percent haze of less than 5%, less than 4%, less than 3%, less than 2%, or less than 1% measured from 360 nm to 780 nm. In some exemplary embodiments, the film may have an average percent haze of from about 1% to about 5% measured from 360 nm to 780 nm, or may have any average percent haze encompassed by these endpoints.

A dense film formed from the UHMWPE polymer may have a matrix tensile strength (MTS) in the machine direction (MD) of at least about 100 MPa, of at least about 200 MPa, of at least about 300 MPa, of at least about 400 MPa, of at least about 600 MPa, or of at least about 800 MPa. In exemplary embodiments, the membrane may have a matrix tensile strength in the machine direction of from about 200 MPa to about 800 MPa, of from about 400 MPa to about 800 MPa, or of from about 600 MPa to about 800 MPa.

A dense UHMWPE film may have a matrix tensile strength (MTS) in the transverse direction (TD) of at least about 100 MPa, of at least about 200 MPa, of at least about 400 MPa, of at least about 500 MPa, of at least about 600 MPa, or of at least about 800 MPa. In exemplary embodiments, the film may have a matrix tensile strength in the transverse direction of from about 400 MPa to about 800 MPa, or of from about 400 MPa to about 600 MPa.

The dense UHMWPE film may have a ratio of the average matrix tensile strength determined as MD:TD from about 1:5 to about 5:1, from about 1:3 to about 3:1, or from about 1:2 to about 2:1.

The dense UHMWPE film, according to an embodiment of the present invention, may be utilized as a barrier film or membrane, exhibiting low CO₂, O₂ or N₂ permeability. For example, the dense UHMWPE film may have a CO₂ permeability of less than 10.0 barrer, less than 5 barrer, less than 1.0 barrer, or less than 0.1, where 1.0 barrer is 3.35×10⁻¹⁶ mol·m/(s·m²·Pa). Similarly, the dense UHMWPE film may have a N₂ permeability of less than 10.0 barrer, less than 5.0 barrer, less than 1.0 barrer, less than 0.1, or less than 0.05 barrer. Additionally, the dense UHMWPE film may have a O₂ permeability of less than 10.0 barrer, less than 5.0 barrer, less than 1.0 barrer, less than 0.1, or less than 0.01 barrer. It is understood that the CO₂, O₂ or N₂ permeability lies within any range formed from the above values, such as the dense film may have a CO₂, O₂ or N₂ permeability from 0.01 to 10 barrer, from 0.1 to 8 barrer or from 0.1 to 6 barrer.

The dense UHMWPE film, according to an embodiment of the present invention, may have a water vapor permeability from 0.01 to 1 g-mm/m²/day, 0.01 to 0.5 g-mm/m²/day, or from 0.01 to 0.25 g-mm/m²/day.

A dense film formed from the UHMWPE polymer may have an average thickness of less than about 1 mm, or less than about 0.1 mm, or less than about 0.01 mm, or less than about 0.001 mm, or less than 0.0005 mm. In exemplary embodiments, the dense film may have a thickness from about 0.0005 to about 1 mm, about 0.001 mm to about 1 mm, or from about 0.001 to about 0.1 mm, or from about 0.001 to about 0.01 mm, or any may have a thickness encompassed within these ranges.

The disclosure further relates to articles and composites including the dense UHMWPE films. The article may be in the form of a film, a fiber, a tube or a three-dimensional self-supporting structure. In an exemplary embodiment, the article is a film. The composite may have two or more layers. The composites may include multiple layers of the present dense UHMWPE films or may include one or more other polymer layers that may be porous and non-porous (such as dense plastic sheets, wovens, non-wovens, electro-spun membranes or other porous membranes) made from materials including, but not limited to high density polyethylene (HDPE), UHMWPE, polyesters, polyurethanes, fluoropolymers, polytetrafluoroethylene, polypropylene, fiberglass, and any combination thereof.

The UHMWPE resin may be provided in a particulate form, for example, in the form of a powder. UHMWPE powders may be formed of individual particles having a particulate size less than about 100 nm. Typically, powders are supplied as a cluster of particles having size from about 5 to about 250 microns or from about 10 microns to about 200 microns. In exemplary embodiments, the clusters may have a size as small as possible, down to and including individual particles.

The UHMWPE films described herein may be manufactured by at least the following methods: (1) Tape compression with subsequent stretch above the melt temperature of the UHMWPE polymer, from about 140° C. to about 170° C. or from about 150° C. to about 160° C. (2) Expansion of a porous dry tape without compression above the melt temperature of the UHMWPE polymer, from about 140° C. to about 170° C. or from about 150° C. to about 160° C.; (3) Compression of a porous UHWMPE membrane above the melt temperature of the UHMWPE polymer, from about 140° C. to about 170° C. or from about 150° C. to about 160° C.; or combined with expansion above the melt temperature of the UHMWPE polymer, from about 140° C. to about 170° C. or from about 150° C. to about 160° C.

In the process utilizing tape compression and above the melt expansion, a dense UHMWPE film from the UHMWPE polymer may be prepared by forming a lubricated wet tape, drying the wet tape for form a dry, porous UHMWPE tape from a UHMWPE polymer having a molecular weight of at least 2,000,000 g/mol and a melt enthalpy of at least 190 J/g. This dry, porous UHMWPE tape is compressed below the melt temperature of the UHMWPE polymer, from about 120° C. to about 135° C. or from about 125° C. to about 130° C. to form a dense UHMWPE tape. This dense tape is then stretched above the melt temperature of the UHMWPE polymer, from about 140° C. to about 170° C. or from about 150° C. to about 160° C.

In forming a dry, porous UHMWPE tape from the UHMWPE polymer, a paste including the UHMWPE polymer as a powder and a lubricant is prepared; followed by shaping the paste into a tape; removing the lubricant to form the dry, porous UHMWPE tape.

To form the paste, UHMWPE polymer as a powder is first mixed with a lubricant, such as a light mineral oil. Other suitable lubricants include aliphatic hydrocarbons, aromatic hydrocarbons, halogenated hydrocarbons, and the like, that are selected according to flammability, evaporation rate, and economical considerations. It is to be appreciated that the term “lubricant”, as used herein, is meant to describe a processing aid consisting of an incompressible fluid that is not a solvent for the polymer at the process conditions. The fluid-polymer surface interactions are such that it is possible to create a homogenous mixture. It is also to be noted that that choice of lubricant is not particularly limiting, and the selection of lubricant is largely a matter of safety and convenience. The lubricant may be added to the UHMWPE polymer in a ratio 1 ml/100 g to about 100 ml/100 g or from about 10 ml/100 g to about 70 ml/100 g. In one embodiment the lubricant is added, the mixture is maintained below the melt temperature of the UHMWPE polymer for a period of time (i.e., dwell time) sufficient to wet the interior of the clusters of the polymer with the lubricant. A “sufficient period of time” may be described as a time period sufficient for the particles to return to a free-flowing powder. In another embodiment, the lubricant is added and mixed with the UHMWPE polymer where the mixture is free flowing and does not require a dwell time.

After the lubricant has been uniformly distributed to the surface of the particles (e.g., wet the interior of the clusters), the mixture returns to a free flowing, powder-like state. In exemplary embodiments, the mixture is heated to a temperature below the melt temperature of the UHMWPE polymer or the boiling point of the lubricant, whichever is lower. It is to be appreciated that various times and temperatures may be used to wet the polymer so long as the lubricant has a sufficient time to adequately wet the interior of the clusters.

Once lubricated, the paste can be formed into solid shapes or a preform, without exceeding the melt temperature of the polymer. In exemplary embodiment, the preform may be a fiber, a tube, a tape, a sheet, or a three-dimensional self-supporting structure. The lubricated particles are heated to a point below melting temperature of the polymer and with the application of sufficient pressure and shear to form inter-particle connections and create a solid form. Non-limiting examples of methods of applying pressure and shear include ram extrusion, typically called paste extrusion, or paste processing when lubricant is present, and optional calendering.

In an exemplary embodiment, the lubricated UHMWPE polymer is calendered to produce a cohesive, flexible tape. As used herein, the term “cohesive” is meant to describe a tape that is sufficiently strong for further processing. The calendering occurs from about 115° C. to about 135° C. or from about 125° C. to about 130° C. The tape formed has an indeterminate length and a thickness less than about 1 mm. Tapes may be formed that have a thickness from about 0.01 mm to about 1 mm from about 0.08 mm to about 0.5 mm, or from 0.05 mm to 0.2 mm, or even thinner. In exemplary embodiments, the tape has a thickness from about 0.05 mm to about 0.2 mm.

In a subsequent step, the lubricant may be removed to form a dry, porous tape. In instances where a mineral oil is used as the lubricant, the lubricant may be removed by washing the tape in hexane or other suitable solvent. The wash solvent is chosen to have excellent solubility for lubricant and sufficient volatility to be removed below the melting point of the resin. If the lubricant is of sufficient volatility, the lubricant may be removed without a washing step, or it may be removed by heat and/or vacuum. The tape is then optionally permitted to dry, typically by air drying. However, any conventional drying method may be used as long as the temperature of heating the sample remains below the melting point of the UHMWPE polymer.

The dry, porous UHMWPE tape or dense UHMWPE film may be cut to suitable sizes for expansion, and then stretched in at least two directions at a temperature above the melt temperature of the UHMWPE polymer, from about 140° C. to about 170° C., or from about 150° C. to about 160° C. to form a dense UHMWPE film, wherein the dense UHMWPE film has a first detectable endotherm from about 135° C. to about 143° C.; a second detectable endotherm from about 145° C. to about 155° C. The stretching may be conducted over a rate of from 20,000%/second, or from about 0.1% to 20,000%/second.

In another alternative, a dense UHMWPE film may be formed without compression by forming a porous UHMWPE tape from a UHMWPE polymer having a molecular weight of at least 2,000,000 g/mol and a melt enthalpy of at least 190 J/g.

The porous UHMWPE tape may then be stretched above the melt temperature of the porous UHMWPE tape, from about 140° C. to about 170° C. or from about 150° C. to about 160° C. forming the dense UHMWPE film including a first endotherm from about 135° C. to about 143° C.; a second detectable endotherm from about 145° C. to about 155° C.

In yet another alternative, a dense UHMWPE film may be formed by compressing a porous UHMWPE membrane with or without subsequent stretching above the melting temperature of the UHWMPE polymer. The porous UHMWPE membrane may be formed as described in U.S. Pat. No. 9,926,416 B2.

In another embodiment, the porous UHMWPE tape may then be stretched below the melt temperature of the porous UHMWPE tape, from about 100° C. to about 135° C. or from about 120° C. to about 130° C. and subsequently or simultaneously compressed at a pressure of at least 1 MPa, thereby forming the dense UHMWPE film including a first endotherm from about 135° C. to about 143° C.; a second detectable endotherm from about 145° C. to about 155° C., this dense film can be combined with stretching above the melt temperature of the UHMWPE polymer, from about 140° C. to about 170° C. or from about 150° C. to about 160° C.

Stretching, either uniaxial or biaxial, may be conducted at rates up to 20,000%/second, or from about 0.1% to 20,000%/second.

The dense UHMWPE films obtained by the processes described above exhibit superior mechanical and optional properties, such as high strength, optical uniformity, low haze, and transparency.

### Test Methods

Although certain methods and equipment are described below, other methods or equipment determined suitable by one of ordinary skill in the art may be alternatively utilized.

### Contact Thickness Measurements

Thickness was measured by placing the sample flat on a granite block and using a hand actuated Mitutoyo thickness gauge (Mitutoyo Corporation, Kawasaki, Japan) with a 6.35 mm metal plate.

### Mass Per Area Measurements

Mass per area measurements were made by weighing the dog bone samples used for mechanical characterization and dividing this mass in grams by the known area of the dog bone in squared meters.

### DSC Measurements

DSC data was collected using a TA Instruments Discovery DSC over a temperature range of −50° C. and 200° C. using a heating rate of 10° C./min. For resin samples, approximately 5 mg of powder was placed into a standard pan-and-lid combination available from TA instruments. The membrane samples were prepared by punching 4 mm disks. The 4 mm disk was placed flat in the pan and the lid was crimped to sandwich the membrane disk between the pan and lid. A linear integration scheme from 80° C. to 180° C. was used to integrate the melting enthalpy data. Subsequent de-convolution of the melting region was accomplished using the PeakFit software from SeaSolve Software (PeakFit v4.12 for Windows, Copyright 2003, SeaSolve Software Inc.). Standard conditions were used to fit a baseline (after inverting the data to generate “positive” peaks) and subsequently resolve the observed data into its individual melting components.

### Tensile Testinq and Matrix Tensile Strength (MTS), Modulus, and Toughness Calculations

Tensile testing was conducted using an Instron® Universal Tensile Tester (Instron Corporation, Norwood, Massachusetts, USA) for the machine direction (MD) and 90° orthogonal transverse direction (TD). ASTM D638-V dogbone tensile specimens were secured in grips 25 mm apart and testing was conducted at a crosshead displacement rate of 1.27 mm/s. The matrix tensile strength (MTS) is used to communicate the tensile strength of a highly porous article, and is calculated using the following formula:

$$MTS = TS * ( {ρ}_{sample} / {ρ}_{pe} )$$

Where TS=tensile strength from the uniaxial tensile testing;
ρₛₐₘₚₗₑ=sample bulk density;
ρₚₑ=theoretical density of PE, taken as 0.95 g/cm³

Modulus was calculated as the maximum slope drawn through and five sequential points of the stress vs strain plot after a load was detected in the test.

Toughness was calculated be integrating the area under the stress vs strain plot.

### Gas Permeability Measurements

Permeability was measured using a Lab Think Perme VacV2 permeability tester (Labthink International, Inc., Bost, MA) following the ASTM method D1434-82 (Standard Test Method for Determining Gas Permeability Characteristics of Plastic Film and Sheeting). Samples were tested by inserting the film into the tester and tested against various individual gases (CO₂, N₂, and O₂). The measured gas transmission rate (GTR) was converted into a permeability coefficient for each gas in units of cm³-cm/cm²-s-cmHg×10⁻¹⁰ or Barrer, representing the rate of gas passing through an area of material with a thickness driven by a given pressure.

### Water Vapor Permeability Measurements

Determination of the water vapor permeability of the materials was carried out following the ASTM method F-1249. The instrument used to test the water vapor permeation of the materials was a MOCON Permatran W 3/34 (MOCON/Modern Controls, Inc., Minneapolis, Minn.). The permeant used was 100% RH water vapor (49.157 mmHg), the carrier gas was 100% nitrogen, dry, at ambient pressure and the temperature at which the test was carried out was 37.8° C. Samples were cut and masked such that the testing area was approximately 0.1287 cm², affixed in the instrument diffusion cell and conditioned according to the instructions for the MOCON Permatran W 3/34. Water vapor transmission rate, or water vapor permeability, was reported by the instrument in g/m²/day. The water vapor permeation coefficient of each sample was calculated by multiplying the water vapor transmission rate by the thickness of the test sample. Results are reported as g-mm/m²/day.

### Optical Property Measurements

Total Luminous Transmittance and Haze % were determined according to ASTM D1003-13 (Standard Test Method for Haze and Luminous Transmittance of Transparent Plastics). The incident light (T1), total light transmitted by the specimen (T2), light scattered by the instrument (T3), and light scattered by the instrument and specimen (T4) were measured over a wavelength range of 360 to 780 nm with a 1 nm step using a Jasco v-670 UV-Vis-NIR spectrophotometer (JASCO Deutschland GmbH, Pfungstadt, Germany) equipped with a Jasco iln-725 integrating sphere. The diffuse luminous transmittance (Td), total luminous transmittance (Tt), and haze % were calculated according to ASTM D1003-13.

### EXAMPLES

It is to be understood that the following examples were conducted on a lab scale but could be readily adapted to a continuous or semi-continuous process.

### Example 1

### Powder Preparation

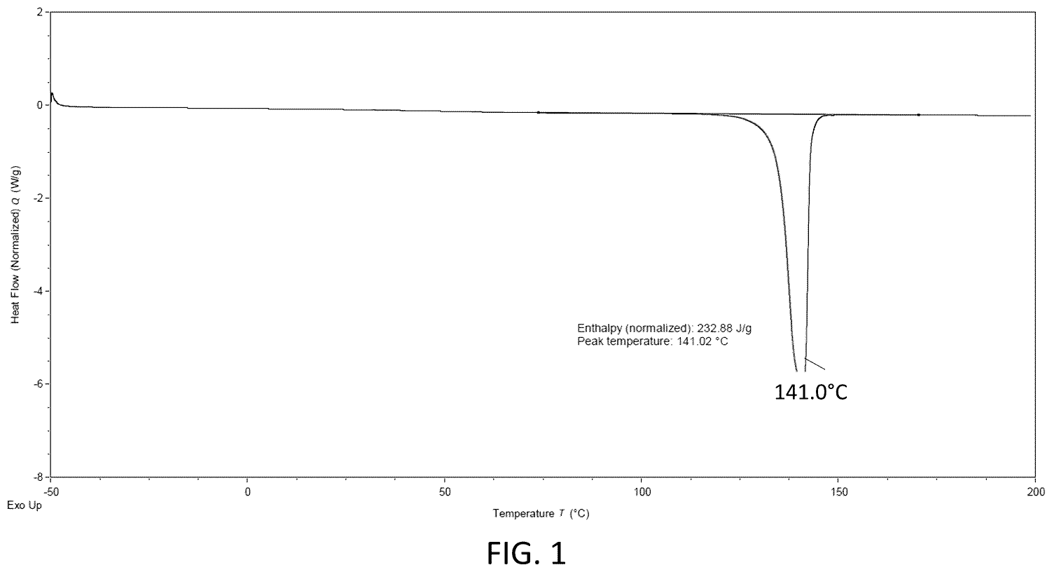

300 g of Ultrahigh Molecular Weight Polyethylene (UHMWPE) powder having a molecular weight of approximately 7,000,000 g/mol (Mitsui Chemicals Inc., made as described in WO2012053261) and a melt enthalpy in excess of 190 J/g as determined by DSC was placed in a 2-liter screw cap jar. FIG. 1 shows a typical DCS thermogram of the UHMWPE powder used. 180 mL of an isoparaffinic hydrocarbon lubricant (ISOPAR™ V; ExxonMobil Chemical Company, Spring, Texas) was added and mixed at room temperature for 15 minutes at 30 rpm using a tumbler. The mixture was preheated to 60° C. prior to calendering.

### Tape Calender Process

Calender rolls with a diameter of 20.3 cm were preheated to 121° C. with the gap between the rolls set at 0.2 mm. The lubricated polymer was introduced into the gap with a feeder to produce a 15.2 cm wide continuous tape at a line speed of 2.0 mpm. The tape was opaque, flexible, and approximately 0.21 mm thick.

### Lubricant Removal

The tape was run roll-to-roll through a large bath containing a low aromatic hydrocarbon solvent (ISOPAR™ G; ExxonMobil Chemical Company, Spring, Texas) to displace the Isopar V™ with Isopar™ G and subsequently dried at 50° C.

### Heated Compression

After lubricant removal, the dried tape was re-calendered between 30.5 cm diameter rolls preheated to 130° C. at a line speed of 0.3 mpm with the gap between the rolls set at 0.09 mm. The resulting compressed tape was translucent and flexible.

### Biaxial Stretching

Samples were cut from the tape and placed in a Karo IV biaxial expansion machine (commercially available from Bruckner Group GmbH, Siegsdorf, Germany) and simultaneously stretched according to the steps below:
1. Preheat the sample at 145° C. for 120 seconds
2. At 145° C.: 9.5× at 37.5%/s in the calendered direction and 9.5× at 37.5%/s in the transverse (perpendicular to the calender) direction

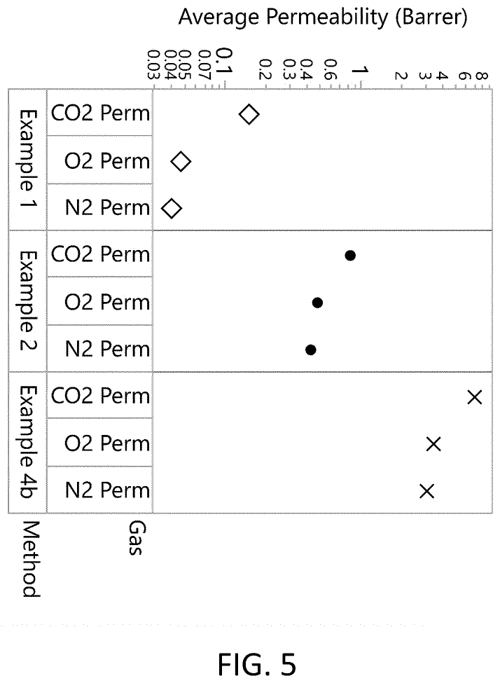

A differential scanning calorimetry (DSC) thermogram depicting two distinct melting points associated with the stretched dense UHMWPE film is included in FIG. 2. Physical, mechanical, gas permeability, water vapor permeability, and optical properties for Example 1 are given in FIG. 5 and TABLE 1.

### Example 2

### Powder Preparation

Powder preparation was conducted according to the method described in Example 1.

### Tape Calender Process

Calender rolls with a diameter of 30.5 cm were preheated to 124° C. with the gap between the rolls set at 0.16 mm. The lubricated polymer was introduced into the gap with a feeder to produce a 15.2 cm wide continuous tape at a line speed of 2.1 mpm. The tape was opaque, flexible, and approximately 0.17 mm thick.

### Lubricant Removal

Lubricant removal was conducted according to the method described in Example 1.

### Biaxial Stretching:

Samples were biaxially stretched as described in Example 1, but according to the steps below:
1. Preheat the sample at 160° C. for 30 seconds
2. At 160° C.: 2.5× at 28%/s in the calendered direction and 9.5× at 70%/s in the transverse (perpendicular to the calender) direction using Constant Rate mode

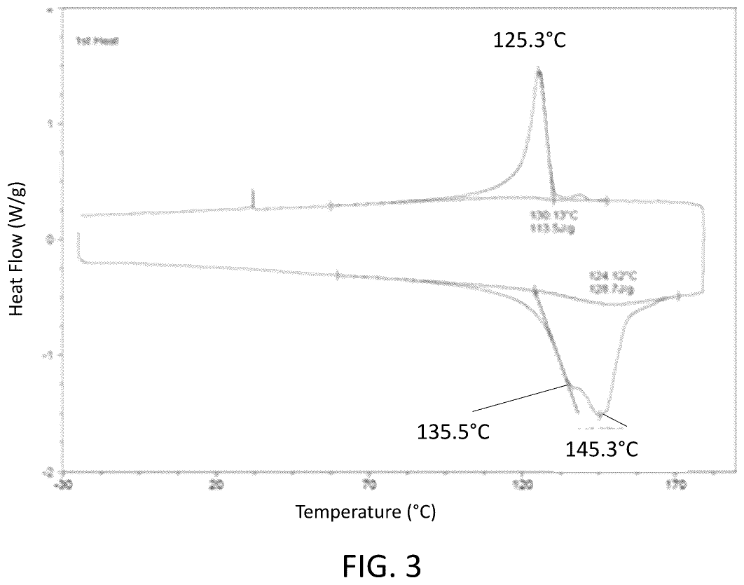

A differential scanning calorimetry (DSC) thermogram depicting two distinct melting points associated with the stretched dense UHMWPE film is included in FIG. 3. Physical, mechanical, and gas permeability properties for Example 2 are given in FIG. 5 and TABLE 1.

### Example 3

### Porous Membrane Creation

A porous polyethylene membrane was prepared as in U.S. Pat. No. 9,926,416 B2. The membrane had a mass per area of 14.7 g/m², a bubble point pressure of 324 kPa, an ATEQ airflow of 7 I/hr @1.2 kPa over a 2.2 cm² area, a calendered direction MTS of 189 MPa and a transverse direction MTS of 183 MPa.

This membrane was used in all subsequent processing.

### Heated Compression

This membrane was cut, and 2 layers were cross plied and then placed on a steel autoclave plate between 2 layers of polymethylpentene film (TPX™, Mitsui Chemicals, Tokyo, Japan) and taped to seal. A vacuum was drawn on the sample and then the temperature and pressure were raised over 45 minutes. Two samples were created at different compression temperatures and subsequent processing.

Example 3a was prepared at a temperature of 155° C. using a pressure of 1.7 MPa.

Example 3b was prepared at a temperature of 160° C. using a pressure of 1.7 MPa.

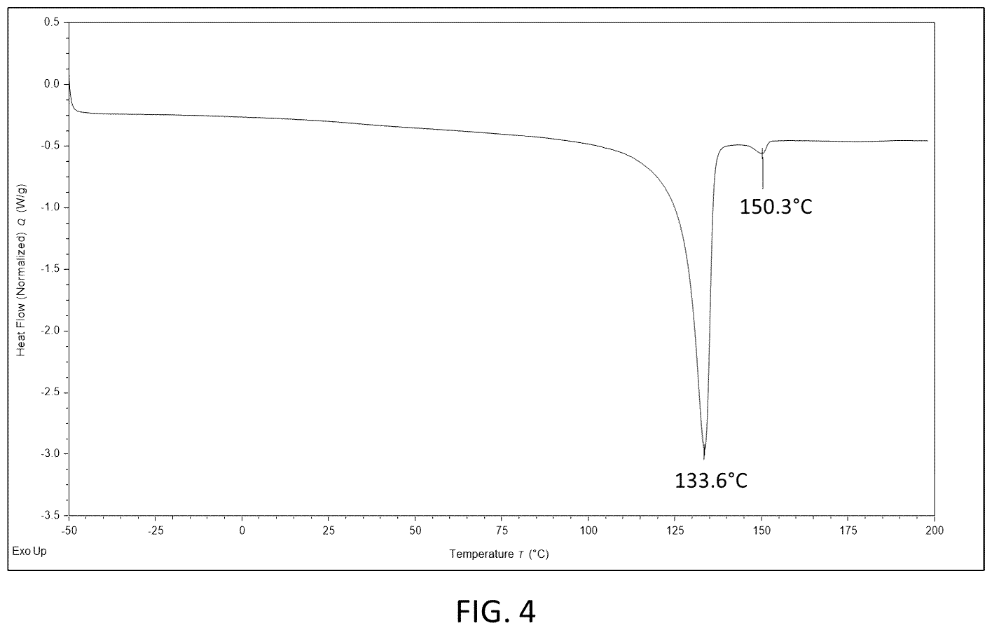

The resulting dense films were clear with no detectable air flow. A DSC thermogram of Example 3a is given in FIG. 4, and the mechanical properties of Example 3a are provided in Table 1.

### Example 4

The dense films formed as Example 3a and Example 3b were further subjected to biaxial stretching.

### Biaxial Stretching

Sections of Example 3a and Example 3b were cut and placed in a Karo IV biaxial stretching machine as described in Example 1 and stretched according to these steps.
1. Example 4a
   a. Preheat the sample (Example 3a) at 155° C. for 30 seconds
   b. At 155° C.: 3.0× at 3%/s in the calendered direction and 3.0× at 3%/s in the transverse direction
2. Example 4b
   a. Preheat the sample (Example 3b) at 155° C. for 30 seconds
   b. At 155° C.: 2.0× at 3%/s in the calendered direction and 2.0× at 3%/s in the transverse direction.

Gas and water vapor permeability data for Example 4b are given in FIG. 5 and Table 1.

TABLE 1

| | | | Matrix | | | | | | | | | | | |
|---|---|---|---|---|---|---|---|---|---|---|---|---|---|---|
| | Mass | | Tensile | | | | | | Optical Properties | | | | | Water Vapor |
| | per | Contact | Strength | | | | | | | Maximum Total | | | | Permeation |
| | Area | Thick- | (MTS) | | Modulus | | Toughness | | Average Haze | Transmittance | Gas Permeability | | | Coefficient |
| | (MPA) | ness | (MPa) | | (MPa) | | (J/m²) | | 360-780 nm | 360-780 nm | (Barrer) | | | H₂O |
| | (g/m²) | (μm) | MD | TD | MD | TD | MD | TD | (%) | (%) | CO₂ | N₂ | O₂ | (g*mm/m²*day) |
| Example 1 | 1.54 | 1.5 | 750 | 556 | 6158 | 2881 | 50 | 84 | 3.5 | 91.5 | 0.15 | 0.05 | 0.04 | 0.017 |
| Example 2 | 5.79 | 7.9 | 203 | 425 | — | — | — | — | — | — | 0.83 | 0.47 | 0.42 | — |
| Example 3a | — | — | 109 | 108 | — | — | — | — | — | — | — | — | — | — |
| Example 3b | — | — | — | — | — | — | — | — | — | — | — | — | — | — |
| Example 4a | — | — | 220 | 219 | — | — | — | — | — | — | — | — | — | — |
| Example 4b | — | — | — | — | — | — | — | — | — | — | 6.89 | 3.43 | 3.06 | 0.202 |

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A dense, ultra-high molecular weight polyethylene (UHMWPE) film comprising:
a first endotherm from about 135° C. to about 143° C.;
a second endotherm from about 145° C. to about 155° C.; and
a total luminous transmittance of at least about 90% measured from 360 nm to 780 nm.

2. The dense UHMWPE film of claim 1, wherein the UHMWPE film has a matrix tensile strength in the machine direction (MD) of least 200 MPa.

3. The dense UHMWPE film of claim 1, wherein the UHMWPE film has a matrix tensile strength in the transverse direction (TD) of least 400 MPa.

4. The dense UHMWPE film of claim 1, wherein the ratio of the matrix tensile strength MD:TD is from about 1:5 to about 5:1.

5. The dense UHMWPE film of claim 1, wherein the UHMWPE film has CO₂ permeability, or an O₂ permeability or a N₂ permeability of less than 10 barrer.

6. The dense UHMWPE film of claim 1, wherein the UHMWPE film has a thickness from 0.0005 mm to 1 mm.

7. The dense UHMWPE film of claim 1, wherein the dense UHMWPE film is formed from a UHMWPE polymer having a molecular weight from about 2,000,000 g/mol to about 10,000,000 g/mol and a melt enthalpy greater than 190 J/g.

8. A composite comprising the dense UHMWPE film of claim 1.

9. An article comprising the dense UHMWPE film of claim 1.

10. A method of forming a dense UHMWPE film comprising:
forming a dry, porous UHMWPE tape from a UHMWPE polymer having a molecular weight of at least 2,000,000 g/mol and a melt enthalpy of at least 190 J/g; and
compressing the dry, porous UHMWPE tape below the melting temperature of the UHMWPE polymer; and
stretching the UHMWPE tape in at least two directions at a temperature above the melt temperature of the UHMWPE polymer to form the dense UHMWPE film, wherein the dense UHMWPE film comprises:
a first detectable endotherm from about 135° C. to about 143° C.; and
a second detectable endotherm from about 145° C. to about 155° C.

11. The method of claim 10 wherein the dense UHMWPE film comprises a total luminous transmittance of at least about 98% measured from 250 nm to 800 nm.

12. The method of claim 10, wherein the forming step comprises:
providing a paste comprising the UHMWPE polymer as a powder and a lubricant;
shaping the paste into a tape;
removing the lubricant to form the dry, porous UHMWPE tape; and
stretching the tape to form a dense UHMWPE film.

13. The method of claim 10, wherein the step of stretching the compressed UHMWPE tape is conducted at a temperature from 140° C. to 170° C. at a rate from about 0.1% to 20,000%/second.

14. The method of claim 10, wherein the dense UHMWPE film additionally comprises a machine direction matrix tensile strength to transverse direction matrix tensile strength ratio from about 1:5 to about 5:1 and a matrix tensile strength of at least 500×500 (MD×TD) MPa; a CO₂, O₂ or N₂ permeability from 0.01 to 10 barrer; and a water vapor permeation coefficient less than 0.02 g-mm/m²/day.

15. A method of forming a dense UHMWPE film, comprising:
forming a dry, porous UHMWPE tape from a UHMWPE polymer having a molecular weight of at least 2,000,000 g/mol and a melt enthalpy of at least 190 J/g; and
stretching the dry, porous UHMWPE tape in at least two directions at a temperature above the melt temperature of the UHMWPE polymer to form the dense UHMWPE film, wherein the dense UHMWPE film comprises:
a first detectable endotherm from about 135° C. to about 143° C.; and
a second detectable endotherm from about 145° C. to about 155° C.

16. The method of claim 15, wherein the forming step comprises:
providing a paste comprising the UHMWPE polymer as a powder and a lubricant;
shaping the paste into a tape;
removing the lubricant to form the dry, porous UHMWPE tape; and
stretching the tape to form a dense UHMWPE film.

17. The method of claim 15, wherein the step of stretching the dry, UHMWPE tape is conducted at a temperature from 140° C. to 170° C. at a rate from about 0.1% to 20,000%/second.

18. The method of claim 15, wherein the dense UHMWPE film further comprises a machine direction matrix tensile strength to transverse direction matrix tensile strength ratio from about 1:5 to about 5:1 and a matrix tensile strength of at least 200×200 (MD×TD) MPa; and a CO₂, O₂ or N₂ permeability from 0.01 to 10 barrer.

19. A method of forming a dense UHMWPE film, comprising:
(a) forming a porous UHMWPE tape from a UHMWPE polymer having a molecular weight of at least 2,000,000 g/mol and a melt enthalpy of at least 190 J/g;
(b) expanding the porous UHMWPE tape below the melt temperature of the porous UHMWPE tape to form a porous membrane; and
(c) compressing the porous UHMWPE membrane at a pressure of at least 1 MPa thereby forming the dense UHMWPE film, comprising:
a first endotherm from about 135° C. to about 143° C.;
a second detectable endotherm from about 145° C. to about 155° C.

20. The method of claim 19, further comprising (d) stretching the dense UHMWPE film above the melting temperature of the UHMWPE polymer.

21. The method of claim 19, wherein the stretching and compressing steps occur simultaneously.

22. The method of claim 19, wherein the post-compression stretching step occurs at a temperature from about 140° C. to about 170° C.

23. The method of claim 19, wherein the dense UHMWPE film further comprises a machine direction matrix tensile strength to transverse direction matrix tensile strength ratio from about 1:5 to about 5:1 and a matrix tensile strength of at least 200×200 (MD×TD) MPa; and a water vapor permeation coefficient less than 0.21 g-mm/m²/day.

24. The method of claim 10, wherein the stretching step comprises biaxial or radial stretching.
